(19) United States
(12) Patent Application Publication
(10) Pub. No.: US 2025/0027361 A1
(43) Pub. Date: Jan. 23, 2025

(54) FLEXIBLE FURNITURE SCREEN

(71) Applicant: Raphael Schlanger, Wilton, CT (US)

(72) Inventor: Raphael Schlanger, Wilton, CT (US)

(21) Appl. No.: 18/751,273

(22) Filed: Jun. 23, 2024

Related U.S. Application Data
(60) Provisional application No. 63/527,118, filed on Jul. 17, 2023.

(51) Int. Cl. E06B 9/11

(52) U.S. Cl. CPC E06B 9/115

(57) ABSTRACT

A flex screen having: a width; a length; a thickness; a plurality of openings having a length and width, with a first opening laterally adjacent a second opening and longitudinally adjacent a third opening; a plurality of stringers, including a first stringer laterally positioned between the first and second openings; and a bridge between the first and third openings. The first opening is laterally bounded between the first and second stringers and longitudinally bounded by the bridge, which serves to span and connect the first and second stringers. The first opening is longitudinally staggered from the second opening and the bridge is connected to the first stringer at a location longitudinally partway along the second opening. The flex screen may be elastically flexed to a flexed orientation, including torsional displacement of the first and second stringers. The lateral width of the first opening is greater than the thickness of one of the first and second stringers.

### BACKGROUND OF THE INVENTION

### (1) Field of the Invention

The present invention relates to a flexible furniture screen. This screen may be a sliding or a fixed screen. More specifically, this invention relates to a screen having openings therethrough.

### (2) Description of the Related Art

Conventional tambour is well-known and is most recognizable as the moveable cover in a roll-top desk. Construction of this tambour is also well-known and consists of a series of parallel slats that are stacked and then laminated to a canvas sheet. The canvas provides a flexure between adjoining slats to create the tambour. The tambour flex panel may alternatively serve as a door, where the opposed edges of the screen are guided within grooves or tracks to allow the screen to serve as a slidable door that may slide within the tracks to an open or closed position.

Fabrication of conventional tambour is a highly labor-intensive process that involves fabricating numerous individual slats, stacking these slats, and finally gluing these slats to the canvas. This translates to reduced throughput and high labor cost for conventional tambour.

Further, conventional tambour results in a flexible door that is completely solid, without openings therethrough. As such, conventional tambour does not allow for air or light to circulate through the screen.

More recently, tambour has been constructed such that the slats may interlock with each other to effectively create a hinge between adjoining slats to eliminate the need for the canvas flexure. However, these tambour configurations still require numerous individual slat components that each have greater complexity and are expensive to produce.

As an alternative to tambour, flex panels have been created that utilize a grid of linear slits in a single panel. The slits are staggered such that the remaining material may flex in torsion, which allow these screens to flex. This includes a series of aligned slits or thin grooves that extend in generally linear longitudinal direction that is generally perpendicular to the flex direction. Adjacent columns of these slits are staggered, leaving ribbons of material therebetween that will torsionally twist when the panel is flexed in the flex direction. An example of this type of panel is marketed as Dutka® Flexible Wood.

These slits are commonly cut through plywood material by laser cutting or slitting with a circular saw blade. These slits are generally very thin in width, thinner than the thickness of the starting panel (i.e. longitudinal depth of the slit). The intent is to merely permit flexing of the panel. While these slits may permit a small amount of air and/or light to pass through, this is not the intent and the panel is more solid than open and is not a true ventilated screen.

It is further recognized that these slits, while allowing the panel to flex in the flex direction, they also result in a panel that may stretch and compress when opposite ends of the panel are pulled apart or pushed together in the lateral direction. This is termed herein as “accordioning” in a manner similar to the expansion and contraction of the namesake musical instrument. This may be an undesirable type of distortion, particularly if the panel is intended for use as a tambour, such as a roll-top desk or a sliding door.

While these flex panels may be less expensive to produce than conventional tambour, they are prone to “accordioning” (as defined herein) such that they are not commonly utilized as tambour panels such as the aforementioned roll-top desk application.

### SUMMARY OF THE INVENTION

In accordance with the present invention, it is desired to create a flexible panel that preferably may be considered as a flex screen that: has openings therethrough for air and/or light to filter therethrough; may be easily flexed without damage to itself; is economical to manufacture; and preferably resists accordioning (as defined herein) in the lateral direction.

In contrast to conventional flex-panels, the present invention utilizes openings or windows instead of slits. These openings have a width much greater than the aforementioned slits of a conventional flex panel. It is preferable that the width of these openings are equal to, or greater, than the thickness of the panel. It is more preferable that the width of these openings are two or more times the thickness of the panel. It is also preferable that these openings have a combined area, as viewed in the plan view, of at least 40% of the overall area of the flex panel. By utilizing openings with such a pronounced width, it is possible to provide a truly ventilated flex panel that allows air and/or light to more effectively pass through and thus may be considered as a flex screen.

Since these openings may potentially exhibit excessive “accordioning”, as defined hereinabove, it is preferable to include bending flexures in the flex panel. These flexures are described in greater detail herein and serve to significantly reduce the “accordioning” deflection described herein, while still permitting the flexure of the flex screen. This allows the ventilated flex panel of the present invention to be effectively substituted for a conventional flex panel or tambour.

It is also preferable that the flex screen include thickened stiffener(s) that are thicker than the flexing portion of the flex screen. The stiffener(s) serve to stiffen the unsupported perimeter portion of the flex screen and minimize excessive flex in the thickness direction. The stiffener(s) may also serve as handles to facilitate manual manipulation and/or operation of the flex screen.

In accordance with the present invention, it has now been found that the forgoing objects and advantages may be readily obtained.

The present invention provides for true and effective ventilation therethrough. This ventilation may allow light and/or air to pass through the flex panel for functional and/or aesthetic benefit.

The present invention also may include additional geometry that permits this flex screen to flex in the flex direction while limiting and/or minimizing accordioning in the lateral direction.

The present invention may be utilized as a flex screen in place of a tambour and/or a conventional flex panel.

Further features of the present invention will become apparent from considering the drawings and ensuing description.

### BRIEF DESCRIPTION OF THE DRAWINGS

The present invention will be more readily understandable from a consideration of the accompanying exemplificative drawings, wherein:

FIG. 1a is a is a plan view of a flattened prior-art flex panel;

FIG. 1b is a perspective view of the prior-art flex panel of FIG. 1a that is shown to be flexed in the flex direction;

FIG. 1c is a perspective detail view of the prior-art flex panel of FIG. 1b that is shown to be flexed in the flex direction;

FIG. 1d is a cross sectional detail view, taken along 76-76, of the prior-art flex panel of FIG. 1a, showing adjacent stringers as flexed and contacting each other;

FIG. 2a is a perspective exploded view of a first embodiment of the present invention, schematically illustrating the general configuration utilizing two flex screens in a sliding-door arrangement. Including a shelf assembly having grooved tracks to receive the flex screen. The flex screens are shown as flexed to approximate the contour of the grooves;

FIG. 2b is a perspective view of the embodiment of FIG. 2a, showing the flex screens as assembled in the grooved tracks of the shelf assembly;

FIG. 2c is a perspective view of the embodiment of FIG. 2a, showing the flex screen as flattened and non-flexed;

FIG. 2d is a cross section view, taken along 79-79, of the flex screen of FIG. 2c;

FIG. 2e is a plan view of the flattened flex screen of FIG. 2c;

FIG. 2f is a cross section detail view, taken along 79-79, of the flattened flex screen and corresponding to the view of FIG. 2d;

FIG. 2g is a perspective detail view of the flattened flex screen and corresponding to the view of FIG. 2c;

FIG. 2h is a perspective view of a flex screen of the embodiment of FIG. 2a that is shown as flexed and corresponding to the view of FIG. 2a;

FIG. 2i is a perspective detail view of the flex screen of FIG. 2h shown as flexed and corresponding to the view of FIG. 2a;

FIG. 2j is a cross section detail view of the flex screen of FIG. 2i along 78-78, showing the stringers as torsionally flexed and displaced during flex of the flex screen;

FIG. 3a is a perspective exploded detail view of a second embodiment of the present invention, showing the longitudinally distal ends of the stringers having a slot to receive a spline;

FIG. 3b is a perspective detail view of the embodiment of FIG. 3a, showing the spline as next assembled to the slots of the stringers to create flexures between adjacent stringers.

FIG. 4a is a perspective exploded detail view of a third embodiment of the present invention, showing the stringers having a tab portion and a strap to be joined to the stringers;

FIG. 4b is a perspective detail view of the embodiment of FIG. 4a, showing the strap as next connected to the tab portion to create flexures between adjacent stringers.

FIG. 5 is a partial plan view of a fourth embodiment of the present invention, corresponding to the view of FIG. 2e, showing a flex panel with stringers having variable width and a stringer axis that is biased from the flex axis and openings having variable width.

### DETAILED DESCRIPTION OF THE INVENTION

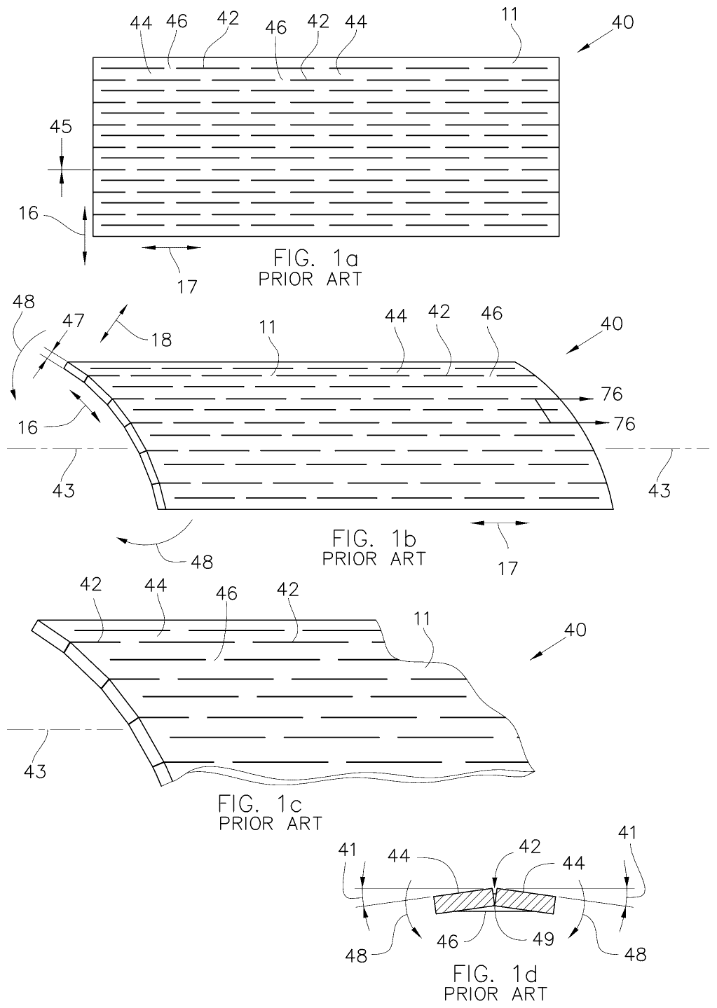

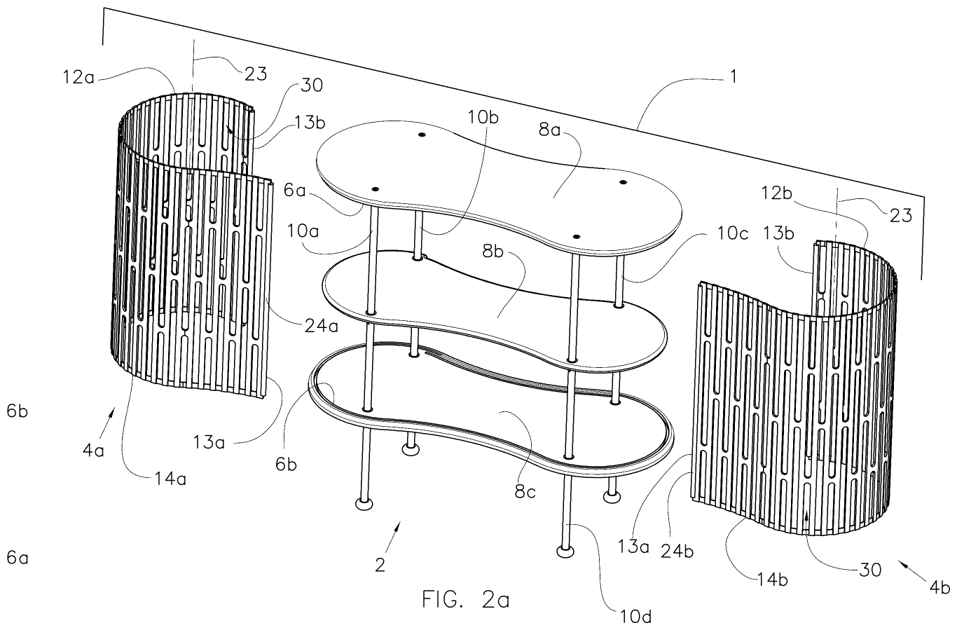

FIGS. 1a-d describe a prior art flex panel 40 that comprises a face surface 11 lattice of stringers 44 that are laterally connected to each other by bridges 46. Stringers 44 are shown to have a thickness 47. The width 45 slits 42 between adjacent stringers is very thin and narrow, commonly much narrower than the thickness 47 of the adjacent stringers 44. The narrow width 45 tends to restrict and limit the amount of air and/or light from passing through the flex panel 40. This is generally the intent of flex panels 40, since the objective is to emulate a solid panel, while allowing that it may be easily bent or warped about a longitudinal axis 43. The “open area” of the flex panel 40 is defined as the ratio of the surface area of the openings pierced by slits 42 to the surface area of the flex panel without the slits 42. In such prior art flex panels, this open area is on the order of approximately 10% or possibly as much as 20%. This minimal level of open area creates a flex panel 40 that functions similar to a solid barrier does not have sufficient open area to provide significant ventilation and/or light transmission. Thus, there is negligible means to provide visible viewing through such a flex panel.

Such flex panels are commonly produced from a solid plywood panel that is strategically cut through its thickness to create the longitudinally staggered slits 42 with stringers 44 laterally straddling each slit 42 as shown. The starting plywood panel may be cut via laser, waterjet, saw, router, or other type of cutting method to create a series of longitudinally aligned slits 42, with bridges 46 therebetween. The slits 42 are commonly created by the kerf (i.e. width of cut) of the cutting method. In other words, the cutter makes only a single longitudinal pass to create each slit 42 such that the width 45 corresponds to the thickness of the saw blade or the diameter of the router bit, etc.

Flex panel 40 has a lateral direction 16, a longitudinal direction 17, and a thickness direction 18. These direction conventions are used throughout this disclosure. Laterally adjacent slits 42 are longitudinally staggered from each other such that a given slit 42 longitudinally overlaps its adjacent bridge 46. Thus, when the flex panel 40 is flexed or warped about a longitudinal flex axis 43 in direction 48, as shown in FIGS. 1b-c, the stringers 44 will torsionally flex and twist as shown in FIG. 1d. FIG. 1d shows two laterally adjacent stringers 44 as each torsionally deflected and twisted in directions 48 by angles 41. Thus, the flex of flex panel 40 about flex axis 43 is facilitated by torsional deflection of stringers 44. Due to the narrow width 45 of slits, the torsional deflection of stringers 44 may serve to further narrow the slits 42, potentially to the point where adjacent stringers 44 may actually contact each other at contact point 49 as shown in FIG. 1d.

It is noted that flex panel 40 does not include thickened handles to be gripped and/or to provide increased stiffness, nor does it include a flexure to reduce accordioning as described hereinbelow. As such, prior art flex panels are commonly used only in stationary applications that are not manipulated to slide in tracks or serve in place of a tambour.

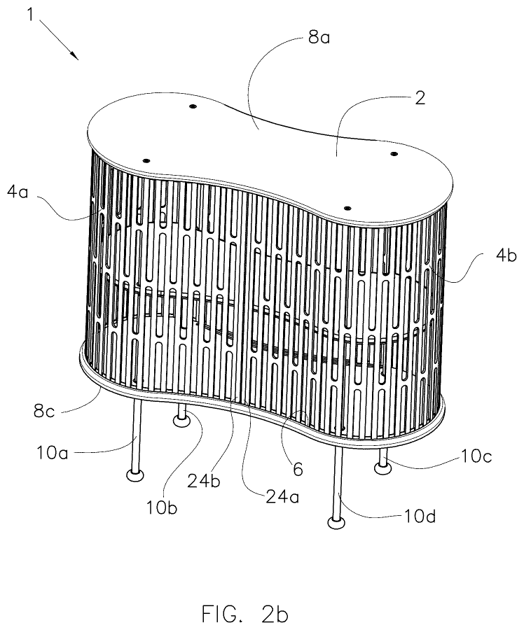

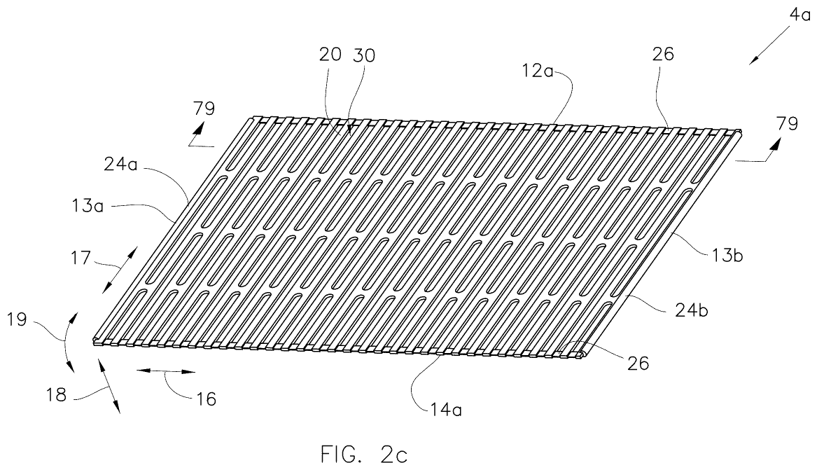

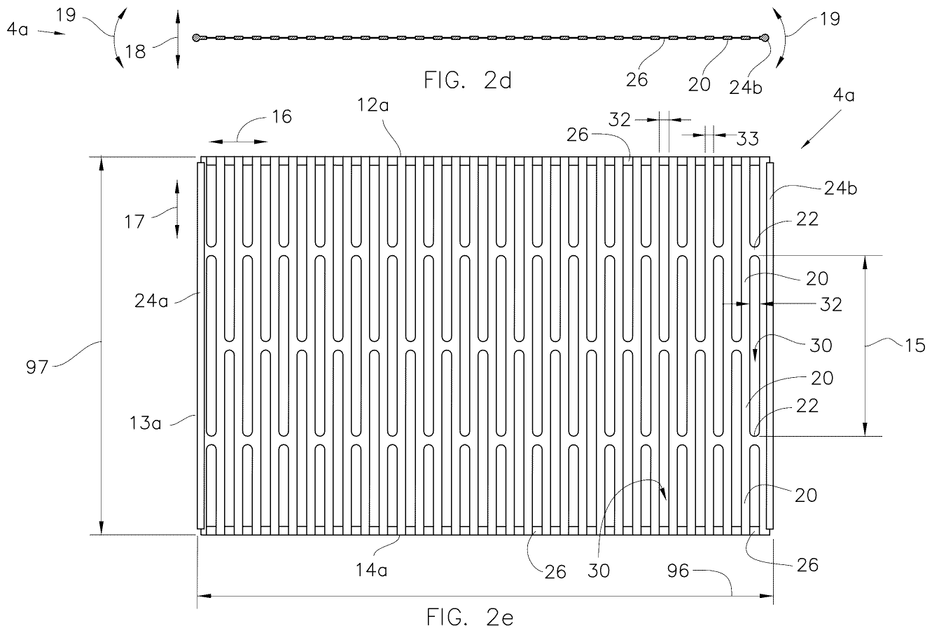

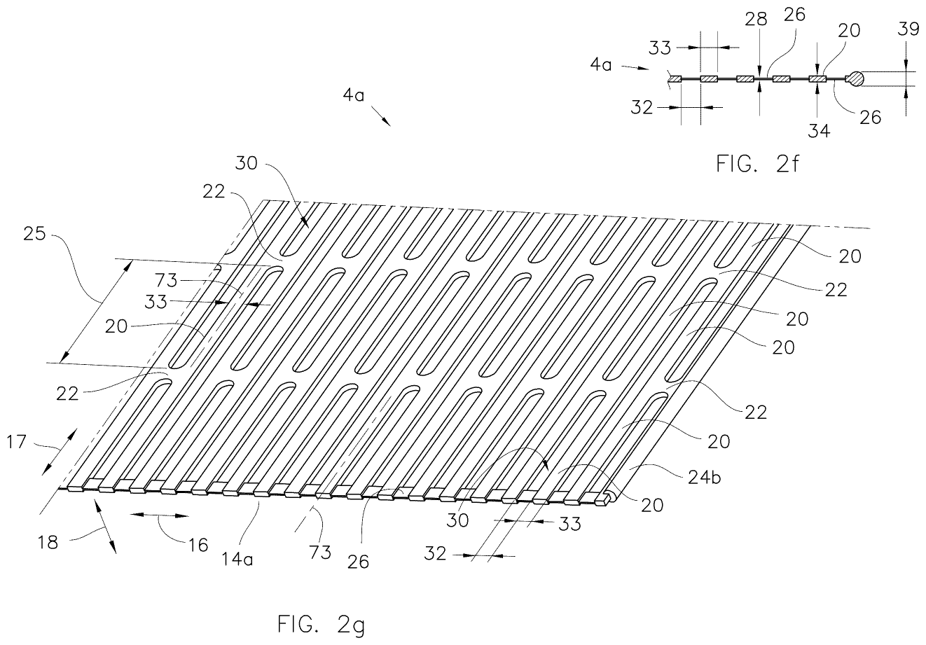

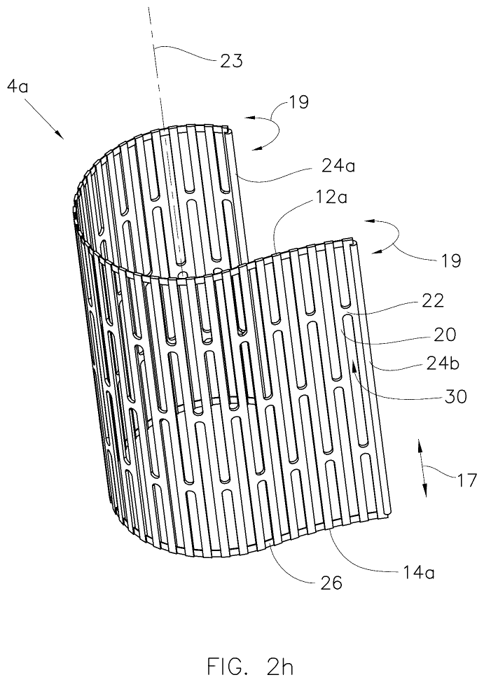

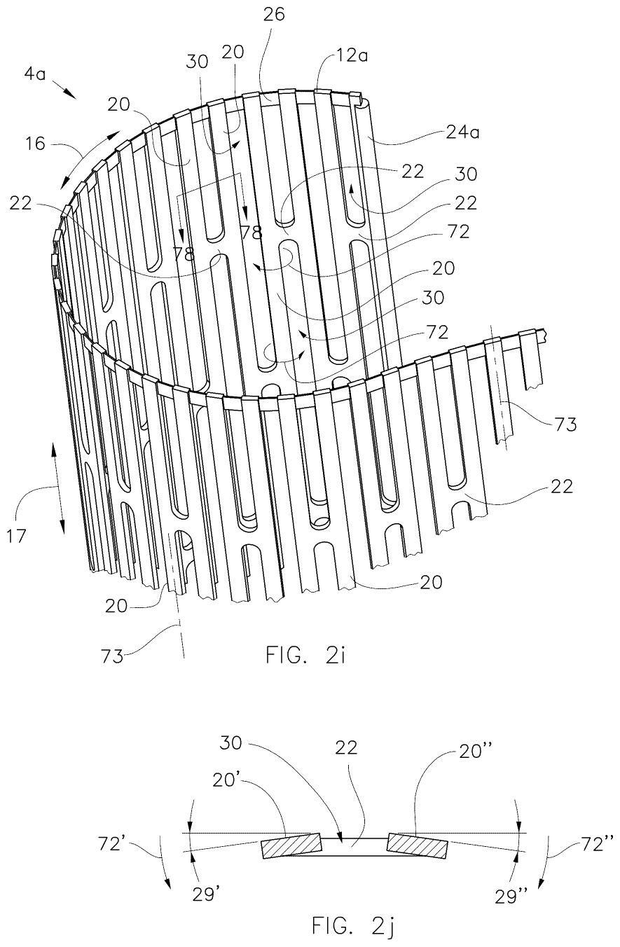

FIG. 2a shows a cabinet 1 of the present invention, serving as a piece of furniture and including shelf assembly 2 and flex screens 4a and 4b. Shelf assembly 2 is shown here to have three shelves 8a-c and four support columns 10a-d that serve to support the shelves 8a-c in the orientation shown. Shelf 8c has a perimeter groove 6b that extends along and adjacent its perimeter as shown. Columns 10a-d serve to support shelves 8a-c and extend to the ground to serve as feet to support the shelf assembly 2. The groove 6b is open in an upwardly facing direction to receive the flex screens 4a and 4b. Shelf 8a has a perimeter groove 6a (obscured) that extends along and adjacent its perimeter. The groove 6a (obscured) is open in a downwardly facing direction and is mirrored to groove 6b to receive the flex screens 4a and/or 4b. It may be seen that grooves 6a and 6b have a curved and “dumbbell” shape to correspondingly guide the flex screens 4a and 4b upon assembly and to clearly illustrate the reverse flexing of flex screens 4a and/or 4b.

Flex screen 4a is shown in FIG. 2a in a flexed orientation such that its upper perimeter edge 12a corresponds to the contours of groove 6a and its lower perimeter edge 14a corresponds to the contours of groove 6b. Similarly, flex screen 4b is shown to be flexed such that its upper perimeter edge 12b corresponds to the contours of groove 6a and its lower perimeter edge 14a corresponds to the contours of groove 6b.

FIG. 2b shows the flex screens 4a and 4b as assembled to the shelf assembly 2 in a flex screen assembly where respective upper perimeter edges 12a and 12b and respective lower perimeter edges 14a and 14b are nested within respective grooves 6a and 6b. Grooves 6a and 6b serve as tracks to guide flex screens 4a and 4b and maintain their flexed orientation. Flex screens 4a and 4b may now be laterally glided and guided within their mating grooves 6a and 6b in a manner similar to a conventional tambour door arrangement. As flex screens 4a and 4b are laterally displaced and glided within grooves 6a and 6b, they will each be correspondingly flexed about a virtual and generally longitudinal flex axis 23 to follow the curvature of grooves 6a and 6b. It may be seen that grooves 6a and 6b serve to retain flex screens 4a and 4b and limit their displacement in both their longitudinal and thickness directions, while permitting displacement in the lateral direction.

FIGS. 2c-g show the flex screen 4a as flattened prior its assembly within shelf assembly 2 to have an overall lateral width 96 between handles 24a and 24b and an overall longitudinal length 97 between upper perimeter edge 12a and lower perimeter edge 12b. It may be preferable to initially form the flex screen 4a in this flattened configuration and then flex the flex screen 4a in the flex direction 19 about flex axis 23 as shown in FIGS. 2a-b for assembly within perimeter grooves 6a and 6b. In their flattened configurations, flex screen 4a may be identical to flex screen 4b. For the purpose of definition herein, the following directional and orientations are described: The lateral direction 16 is a direction along the perimeter edges 12a-b and 14a-b and generally perpendicular to the flex axis 23, whether the flex screen 4a is flattened or flexed. The longitudinal direction 17 is a direction generally perpendicular to the lateral direction 16 and generally parallel to the flex axis 23. The thickness direction 18 is a direction perpendicular to both the longitudinal direction 17 and lateral direction 16 and is a direction along the thickness of the flex panel 4a. The flex direction 19 is the primary flexure direction of the flex screen 4a, such that it may be flexed and curved about a longitudinally extending flex axis 23 as shown in FIGS. 2a-b. Longitudinal direction 17 is a generally linear direction while the lateral direction is a direction generally along the perimeter edges 12a and 14a and may be linear when the flex panel 4a is flattened and may be curved along with the flex screen 4a as it is flexed as described herein.

The flex screen 4a comprises a lattice of stringers 20 that are laterally connected to each other by bridges 22 and flexures 26. The lateral perimeter edges 13a and 13b of the flex screen 4a each include respective longitudinally-extending thickened handles 24a and 24b to allow the operator to comfortably grip the flex screen 4a when manually gliding it within grooves 6a and 6b as previously described.

Stringers 20 are shown to have a thickness 34 and a lateral width 33. Along perimeter edges 12a and 14a, this thickness 34 corresponds to the width of grooves 6a and/or 6b, preferably with a thickness clearance therebetween as is common in conventional tambour door applications. This clearance allows the flex screen 4a to glide within perimeter grooves 6a and 6b, with the flex screens 4a and 4b passively flexing, as dictated by the variable curvature of grooves 6a and 6b.

Handles 24a and 24b provide a convenient handle for manual gripping and manipulation of the flex screen 4a. Handles 24a and 24b may also have a thickness 39 that is greater than the thickness 34 of stringers 20 and thus also serve to stiffen the respective longitudinal perimeter edges 13a and 13b and restrain bowing and flex in the thickness direction 18.

Stringers 20 have a lateral width 33 and span by longitudinal length 25 between its connection to bridges 22. Lateral width 33 is shown here to be generally uniform, except where they flare slightly at their connections with longitudinally adjacent bridges 22. Bridges 22 extend generally laterally to connect and link laterally adjacent stringers 20 to each other. The stringers 20 themselves are shown to extend along a generally longitudinal stringer axis 73 between bridges 22 and or between a bridge 22 and a flexure 26. It may be seen that adjacent bridges 22 are also longitudinally staggered as shown. This means that any of the bridges 22 serve to connect only two laterally adjacent stringers 20. While a given stringer 20 may be connected to two bridges 22, these bridges 22 are longitudinally spaced from each other. Thus, when the flex screen 4a is flexed in the flex direction 19, the stringer 20 will torsionally twist and torsionally deflect in direction 72 (FIG. 2i) about a generally longitudinal axis to provide for the flexing of the flex screen 4a and shown in FIGS. 2a-b. This torsional twist is particularly illustrated in FIG. 2j, where adjacent individual stringers 20′ and 20″ are shown to be torsionally deflected in respective directions 72′ and 72″ by respective angles 29′ and 29″, each about a longitudinal axis along the respective stringer. Meanwhile, the bridge 22 serves to link the terminus of these stringers 20′ and 20″ to each other. This torsional twisting of the stringers 20 serves to facilitate the flex of the flex screen 4a in the flex direction 19. It is preferable that the longitudinal length 25 of stringer 20 be at least twice its lateral width 33 and at least twice its thickness 34 to provide that this torsional deflection occurs within the elastic limit of the material of the stringer 20. It may be preferable that the bridges 22 be generally rigid and do not flex appreciably due to this torsional deflection and the corresponding flex of flex screen 4a about flex axis 23. Alternatively, bridges 22 may have a degree of flex in the flex direction 19 due to the flex about flex axis 23.

It is noted that, unlike the slits of FIGS. 1a-c, openings 30 are of generous opening width 32, such that when the flex screen 4a is flexed in flex direction 19, the adjacent stringers 20 do not contact each other and sufficient light and air may pass through openings 30. Openings 30 have a longitudinal length 15 that is shown here to be greater than their lateral width 32. It is preferable that length 15 be at least twice width 32 to optimize torsional deflection of stringers 20 and elastic flexing in flex direction 19. It is also envisioned that length 15 may alternatively be equal to, or even less than, width 32, but this arrangement has the potential to result in sub-optimal geometry of stringers and/or bridges, where the elastic flexing and/or structural integrity and/or optimal open area of the flex screen may be difficult to maintain. The “open area” of the flex screen 4a is defined as the ratio of the surface area of the pierced openings 30 to the surface area of the flex panel 4a without the openings 30. It is preferable that the open area be at least 40%, or preferably greater than 50%. This level of open area creates a flex screen 4b that functions as a true “screen” and provides meaningful ventilation and/or light transmission therethrough. This also provides for sufficient visible viewing through the flex screen 4a with only minimal visibility restriction (in contrast to the prior-art flex panel 40), allowing the user to visually identify objects through the flex screen 4a. An open area greater than 85% may potentially result in sub-optimal geometry of the stringers and/or bridges, where these elements are too thin to provide sufficient structure of the flex screen.

Bridges 22 also serve to link and connect laterally adjacent stringers 22 and also serve to resist these stringers' 20 longitudinal displacement relative to each other. By linking and joining the stringers 22 with bridges, the overall squareness (in the longitudinal direction 16 and lateral direction 16) of the flex screen 4a is maintained and any in-plane racking or parallelogram distortion is minimized. Conversely, if there were significant longitudinal displacement between adjacent stringers 22, the overall flex screen could experience significant and adverse in-plane distortion such as racking or parallelogramming where the squareness of the flex screen 4a is not maintained. This could cause the flex screen 4a to bind within grooves 6a and 6b and or cause its longitudinal length 97 to be reduced, adversely allowing the perimeter edges 12a and/or 14a to be released from mating grooves 6a and/or 6b.

The material and dimensions of the stringers 20 may be specified such that they may be relatively easily twisted without high torsional stiffness and torsional resistance. This allows the flex screen 4a to easily flex in flex direction 19 such that it may take on the curvature shown in FIGS. 2a and 2b and may be passively flexed as the flex screen is glided and tracked within grooves 6a and 6b. It is preferable that stresses within the stringer 20 due to twisting be within the elastic limit its material such that the flex screen 4a may be operated and flexed multiple times without degradation or failure.

Depending on the material used to form the flex screen 4a, including the thickness and other dimensions of the flex screen 4a, the stringers 20 may also be easily flexed in the lateral direction 16. Thus, as the flex screen 20 is manually operated by handles 24a and/or 24b, the stringers 20 may flex laterally toward each other (as handle 24a is laterally pushed toward handle 24b) or away from each other (as handle 24a is laterally pulled away from handle 24b). Correspondingly the flex screen 4a may deflect to compress (i.e. compress) and/or extend (i.e. stretch) in the lateral direction 16, resulting in an overall “accordioning” of the flex screen 4a, where the flex screen is adversely compressed and stretched like an accordion.

To provide resistance to this accordioning, it may be preferable to include features that limit or restrict this aforementioned lateral flex. These features serve to restrain lateral displacement between adjacent stringers 20 to correspondingly restrain lateral compression and/or lateral stretch. One example of such a feature is to include flexures 26 that connect between adjacent stringers as shown in FIGS. 2a-i. Flexures 26 are webs of structural material that span between laterally adjacent stringers 20 and are preferably longitudinally aligned as shown. These flexures 26 are generally thinner and/or of more pliable and flexible material than bridges 22 such that they may serve as flexible hinges that can be easily flexed in the flex direction 19 while also providing resistance to lateral displacement between these adjacent stringers 20. As such, the two continuous lateral rows of flexures 26, interspersed between adjacent stringers 20, that are shown in FIGS. 2a-i to be adjacent respective perimeter edges 12a and 14a, serve to provide significant resistance to the aforementioned accordioning of the flex screen 4a. It is preferred that this continuous lateral row of flexures 26 and stringers 20 extend along the full lateral width 96 of flex screen 4a as shown to provide maximum resistance to accordioning.

In flexing the flex screen 4a in the flex direction 19, it is preferred that flexures 26 function to provide to provide reduced or minimized resistance to deflection of the stingers 20 in the flex direction, while also reducing deflection of the stringers 20 in the lateral direction 16. This may be achieved either by reducing the thickness 28 of the flexures 26 (i. e. making flexures 26 thinner than the adjoining stringer 20) and/or by utilizing a flexure 26 that is made from a different material that has reduced material stiffness relative to the material of the adjoining stringer 20. For example, the flexure 26 may be made of a resilient material such as rubber, while the adjoining stringer may be made of wood. The rubber material has a lower material stiffness (i.e. flexural modulus) than the wood. It is understood that the term “material stiffness” refers to an intrinsic property of the material itself that is irrespective of the dimension.

As particularly shown in FIG. 2f, flexures 26 have a thickness 28 that is thinner than thickness 34 of stringers 20. The flexures 26 are preferably of a dimension and/or material that will permit adjacent stringers to deflect relative to each other in the flex direction, while resisting lateral displacement therebetween. It is preferable that flexures 26 are of sufficient thickness to resist compressive buckling in the lateral direction 16. These flexures 26 may be formed directly within the material of the remainder of the flex screen 4a. Alternatively, the flexures 26 may be in a second element that is joined or connected to the stringers.

As an alternative to the flex hinge of flexures 26, a true mechanical swivel or hinge may be substituted to provide this hinged connection between adjacent stringers while also resisting accordioning in the manner previously provided. An example of such a mechanical hinge includes a conventional hinge knuckle and hinge pin arrangement that provide a swivel about a longitudinal axis. Such a hinge may provide even less resistance to flexing than the flexures 26.

As shown in FIGS. 2a-i, flex screen 4a also includes openings 30 therethrough that are laterally bounded between adjacent stringers 20 and have a lateral opening width 32. Openings 30 are longitudinally bounded between bridges 22 and/or flexures 26 as shown. It is preferable that the opening width 32 be large enough to allow a significant amount of light and/or air to pass through the flex screen 4a. As such, it is preferable that the opening width 32 be equal to or greater than the thickness 34 of the adjoining stringers 20. It is more preferable that the opening width 32 be equal to or greater than twice the thickness 34. It is still more preferable that the opening width 32 be equal to or greater than three times the thickness 34. It may also be preferable that the opening width 32 be equal to or greater than the lateral stringer width 33 of the stringer 20.

An exemplary method of producing the flex panel 4a may include a fabrication process that starts with a solid panel of material having a thickness corresponding to stringer thickness 34 and with lateral and longitudinal dimensions corresponding to the dimensions of the flattened flex screen 4a. The starting solid panel may be of a variety of materials that are commonly available in sheet form, including plywood, metal sheet, plastic panel, among others. For furniture applications plywood may be a preferable panel material. This panel may then be cut through to create openings 30 by any of the aforementioned cutting method examples. This may be optionally achieved through automated methods such as CNC routing and/or laser cutting among other methods. The lateral width 32 of openings 30 are commonly wider than the kerf of the cutting method. Due to its generous lateral width 32, the opening is commonly produced by a profile cut produced by the cutter associated with the cutting method. In other words, the cutter commonly cuts along the perimeter of opening 30, doubling back to make two (or more) longitudinal passes to create each opening such that the lateral width 32 is greater than the width of the kerf of the cutting method. As such, the lateral width 32 may be greater than the thickness of the saw blade or the diameter of the router bit, etc.

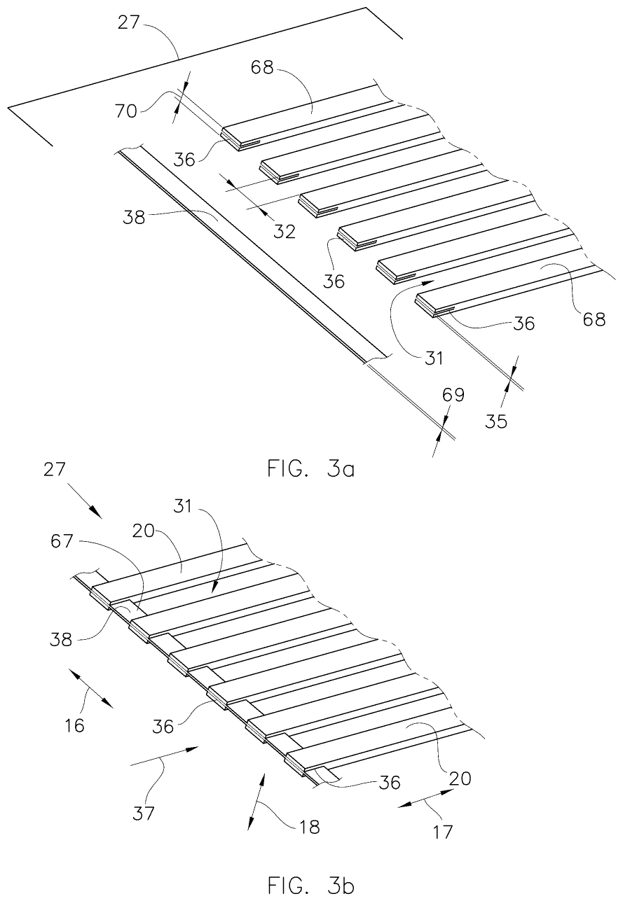

The panel may also be milled to reduce thickness in strategic regions to optionally create flexures 26. Alternatively, these optional flexures 26 may be separately formed and then joined to the flex panel 4a, either as individual flexures 26 or as a continuous strip to create multiple flexures 26. Examples of such separately formed flexures 26 are described I FIGS. 3a-b and 4a-b. Optional handles 24a and 24b may be connected to, or otherwise incorporated with, the flex screen 4a as shown. Bridges 22 may be the same thickness as stringers 20.

An example where the flexures corresponding to flexures 26 are in a second element is shown in the flex screen 27 shown in FIGS. 3a-b. As shown in FIG. 3a, the stringers 68 may be initially formed without the flexures 26, leaving lateral gaps 31 therebetween at their longitudinally distal ends. Gaps 31 are shown here to correspond to lateral opening width 32 of FIGS. 2a-j, although gaps 31 may alternatively be wider or narrower than lateral opening width 32. The stringers 68 are identical to stringers 20 with the exception that they include slots 36 of thickness 35 in their longitudinally distal ends to receive a spline 38 having a thickness 69 that corresponds to thickness 35. As shown in FIG. 3b, the spline 38 is inserted in direction 37 within slots 36. The spline 38 is preferably laterally continuous to span laterally between all of the stringers 68 and their associated slots 36. The portion of the spline 38 that spans laterally between adjacent stringers 68 serves as a flexure 67 as described hereinabove referring to flexure 26. The spline 38 may be glued or otherwise joined to the stringers 68 within the slots 36. The thickness 69 of spline 38 is thinner than thickness 70 and permits flexing between adjacent stringers 68 in the flex direction 19 while also resisting lateral displacement therebetween. The spline 38 may also be of a different material than the remainder of the flex screen 4a and this material may be optimized for such flexure. For example, the stringers 68 may be made of plywood, while the spline 38 may be made of a resilient plastic or of metallic material. Alternatively, the spline may be made or hardwood, preferably having the grain oriented along the lateral direction 16.

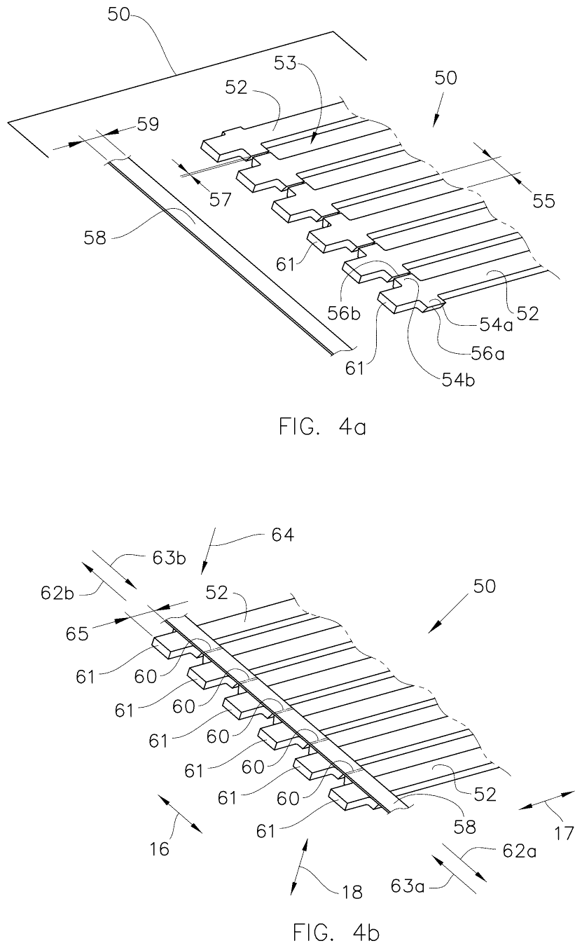

The embodiment of FIGS. 4a-b describes an alternate arrangement for creating the function of flexures 26. Flex panel 50 is of similar arrangement to flex panel 4a and includes a lateral row of adjacent stringers 52, with openings 53 therebetween. Stringers 52 are similar to stringers 20, except that they each include tabs 54a and 54b incorporated therein, with each tab 54a and 54b including respective edges 56a and 56b. Tabs 54a and 54b flare laterally outwardly from the main body of each stringer 52 such that edges 56a and 56b of adjacent stringers are proximal to each other with a reduced gap 57 therebetween. Gap 57 is shown to have a narrower lateral width than the width 55 of openings 53. Tabs 54a and 54b are preferably longitudinally aligned with each other and are preferably positioned toward the longitudinal terminus 61 of the stringers 52.

As shown in FIG. 4a, strap 58 extends laterally with a longitudinal width 59 and is made of a generally thin and flexible material such as a woven fabric or polymer strip. Next, as shown in FIG. 4b, strap 58 is joined, by adhesive or other means, in direction 64 to the flex screen 50 to extend continuously along and overlying the tabs 56a and 56b of stringers 52. Strap 58 spans across gaps 57 as shown, thereby connecting the adjacent stringers 52 to each other. Strap 58 is flexible and serves as a flex hinge between adjacent edges 56a and 56b, permitting hinged movement between adjacent stringers 52 in a manner similar to flexures 26.

The strap 58 may be of fabric material that may be easily buckled when laterally compressed in directions 63a and 63b and may be very strong and resistant to deflection when laterally stretched in directions 62a and 62b. Thus, the strap 58 serves to resist accordioning of the flex screen 50 when it is laterally outwardly stretched in directions 62a and 62b. Furthermore, it may be preferred that gap 57 be very small, providing the minimum lateral dimension required for hinged displacement at adjacent edges 56a and 56b. Thus, when the flex screen 50 is laterally inwardly compressed in directions 63a and 63b, the stringers 52 will flex a minute amount to allow the gap 57 to quickly close such that adjacent edges 56a and 56b will abut each other, thereby limiting accordioning of the flex screen 50 when it is laterally inwardly compressed in directions 63a and 63b. Thus, it may be seen that the arrangement of FIGS. 4a-b serves to resist accordioning of the flex screen 50, while also permitting flexure in the flex direction. Further, as shown in FIGS. 4a-b, the strap 58 is longitudinally offset by distance 65 from the longitudinal terminus' 61. Alternatively, the strap may be longitudinally coincident with the longitudinal terminus' 61.

While the strap 58 is shown to be joined to the portion of the stringers 52 that include tabs 54a and 54b, it is envisioned that the strap may alternatively be joined to portion(s) of the stringers 52 that are longitudinally offset from the tabs 54a and 54b. It is also envisioned that the strap 58 may be utilized in conjunction with stringers that do not have tabs 54a and 54b.

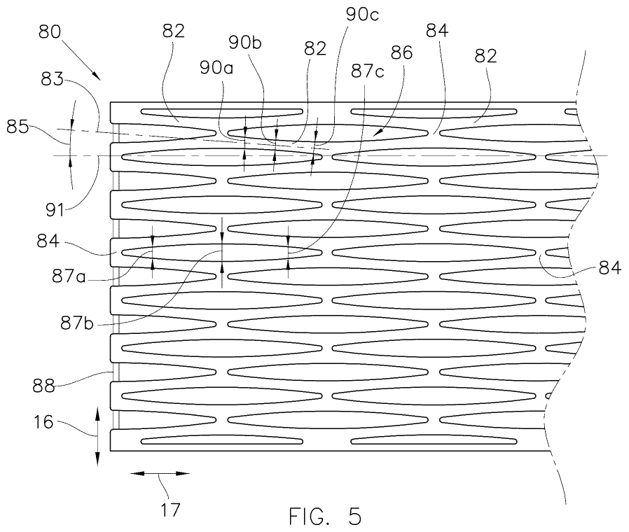

The embodiment of FIG. 5 is provided to show an example of the broad range of potential geometry and form that the stringers, bridges, and openings may employ. Flex screen 80 includes stringers 82, bridges 84, openings 86, and flexures 88 that function in a similar manner to their namesake elements of flex screen 4a.

While the embodiment of FIGS. 4a-j show stringers 20 to have a generally uniform width 33, the stringers 82 have a variable width to include a portion thereof having width 90b that is shown to be narrower than other portions having widths 90a and 90c. While stringers 20 are shown to extend in a purely longitudinal direction 17, stringers 82 extend generally along a stringer axis 83 that has a bias angle 85 from the longitudinal bending axis 91, such that stringer axis 83 extends to have both lateral and longitudinal directional components. The stringer axis may alternatively have other orientations as well, including arcuate orientations and stepped/jogged orientations. While openings 30 of FIGS. 2a-j are shown with straight longitudinal sides to have a generally uniform lateral width 32, openings 86 are shown to have an elliptical shape with arcuate sides and correspondingly have a variable lateral width, including a portion thereof having width 87b that is wider than other portions having widths 87a and 87c.

It may be seen that the flex screen of the present invention may utilize a wide variety of alternative geometries that may serve to provide enhancement to the flex characteristic of the flex screen and/or may also provide an alternative aesthetic appearance as well. For example, due to the bias angle 85 of stringer axis 83, when the flex screen 80 is flexed about a longitudinal flex axis 91 in a manner similar to that described in FIGS. 2a-j, stringers 82 may flex and warp in both a twisting/torsional deflection (as described in FIGS. 2a-j) and a bending deflection. Because the bias angle is very small, the bending portion of deflection will be very slight, with the majority portion of deflection being torsional deflection.

While my above description contains many specificities, these should not be construed as limitations on the scope of the invention, but as merely providing exemplary illustrations of some of the preferred embodiments of this invention. For example:

The flex panel 4a is shown to have stringers 20 and bridges 22 of generally uniform thickness. These stringers 20 and bridges 22 may alternatively be of different thicknesses. Further, the stringers 20 and bridges 22 may themselves be contoured to have varying thicknesses.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications that are within its spirit and scope as defined by the claims.

What is claimed is:

1. A flex screen including:
a lateral screen width along a lateral direction, a longitudinal screen length along a longitudinal direction, a screen thickness along a thickness direction; a first perimeter edge along said lateral width and a second perimeter edge longitudinally opposed and spaced from said first perimeter edge;
a plurality of openings extending through said screen thickness and having a longitudinal length and a lateral width, including a first opening laterally adjacent a second opening and longitudinally adjacent a third opening;
a plurality of elongated stringers extending along a stringer axis, including a first stringer laterally positioned between said first opening and said second opening;
a plurality of laterally extending bridges, including a first bridge longitudinally positioned between said first opening and said third opening;
wherein said first opening is laterally bounded between said first stringer and a second of said stringers and is longitudinally bounded by said first bridge; said first bridge serving to span and connect said first stringer to said second stringer;
wherein said first opening is longitudinally staggered from said second opening such that said first bridge is connected to said first stringer at a location longitudinally partway along said second opening;
wherein said flex screen may be elastically flexed to a flexed orientation about a flex axis such that laterally spaced portions thereof are displaced from each other in said thickness direction;
wherein said elastic flex includes the torsional displacement of said first stringer and said second stringer;
wherein the lateral width of said first opening is greater than the thickness of at least one of said first stringer and said second stringer.

2. The flex screen according to claim 1, wherein the lateral width of said first opening is at least twice the thickness of at least one of said first stringer and said second stringer.

3. The flex screen according to claim 1, wherein said longitudinal length of said opening is greater than its lateral width.

4. The flex screen according to claim 1, including an open area of said flex screen, wherein said open area is at least 40%.

5. The flex screen according to claim 1, wherein said flex screen is configured to be supported adjacent said first perimeter edge.

6. The flex screen according to claim 1, including a furniture element, wherein said furniture element includes a laterally extending track configured to receive said first perimeter edge, and wherein, with said first perimeter edge engaged to said track, said track serves to maintain said flexed orientation.

7. The flex screen according to claim 6, wherein said furniture element includes a second track longitudinally opposed to said track, said second track is configured to receive said second perimeter edge, wherein, with said second perimeter edge engaged to said second track, said track serves to maintain said flexed orientation.

8. The flex screen according to claim 6, wherein said flex screen may be laterally displaced relative to said furniture element along said track.

9. The flex screen according to claim 6, wherein said track serves to limit displacement of said flex screen therefrom in both the longitudinal and thickness directions.

10. The flex screen according to claim 1, wherein said stringer is an elongated element spanning along a stringer axis between a first of said bridges and a second of said bridges, wherein said stringer axis extends in a longitudinal direction.

11. The flex screen according to claim 1, wherein said stringer is an elongated element spanning along a stringer axis between a first of said bridges and a second of said bridges, wherein said stringer axis extends in a direction that includes both longitudinal and lateral directional components.

12. The flex screen according to claim 1, wherein said stringer is an elongated element having an elongated stringer length spanning between a first of said bridges and a second of said bridges, and a stringer width perpendicular to said stringer length, wherein said stringer width is generally constant along the majority of said stringer length.

13. The flex screen according to claim 1, wherein said stringer is an elongated element having an elongated stringer length spanning between a first of said bridges and a second of said bridges, and a stringer width perpendicular to said stringer length, wherein said stringer width is variable along said stringer length.

14. The flex screen according to claim 1, wherein said first opening has a generally uniform lateral width along the majority of its longitudinal length.

15. The flex screen according to claim 1, wherein said first opening has a generally variable lateral width along its longitudinal length.

16. The flex screen according to claim 1, wherein said bridge portion is generally rigid and without appreciable flexural displacement due to said flexure of said flex screen about said flex axis.

17. A flex screen including:
a lateral screen width along a lateral direction, a longitudinal screen length along a longitudinal direction, a screen thickness along a thickness direction; a first perimeter edge along said lateral width and a second perimeter edge longitudinally opposed and spaced from said first perimeter edge;
a plurality of openings extending through said screen thickness and having a longitudinal length and a lateral width, including a first opening laterally adjacent a second opening and longitudinally adjacent a third opening;
a plurality of elongated stringers extending along a stringer axis, including a first stringer laterally positioned between said first opening and said second opening;
a plurality of laterally extending bridges, including a first bridge longitudinally positioned between said first opening and said third opening;
wherein said first opening is laterally bounded between said first stringer and a second of said stringers and is longitudinally bounded by said first bridge; said first bridge serving to span and connect said first stringer to said second stringer;
wherein said first opening is longitudinally staggered from said second opening such that said first bridge is connected to said first stringer at a location longitudinally partway along said second opening;
wherein said flex screen may be elastically flexed to a flexed orientation about a flex axis such that laterally spaced portions thereof are displaced from each other in said thickness direction;
wherein said elastic flex includes the torsional displacement of said first stringer and said second stringer;
including a flexure spanning laterally between said first stringer and said second stringer, wherein said flexure permits flexure of said flex screen about said flex axis while also resisting accordioning of said flex screen in said lateral direction; and
wherein at least one of (i) the vertical thickness of said flexure is less than the vertical thickness of at least one of said bridge and said first stringer; and (ii) the flexural modulus of the material of said flexure is less than the flexural modulus of the material of said first stringer.

18. The flex screen according to claim 17, wherein said flexure is adjacent said first perimeter edge.

19. The flex screen according to claim 17, wherein said flexure is longitudinally spaced from said first perimeter edge.

20. The flex screen according to claim 17, including a plurality of said flexures to include a first flexure and a second flexure, wherein said first flexure is laterally spaced from said second flexure.

21. The flex screen according to claim 20, including a plurality of said flexures to create a lateral series of said flexures interspersed between said plurality of said stringers.

22. The flex screen according to claim 21, wherein said lateral series of said flexures extends along said lateral screen width.
